(19) United States
(12) Patent Application Publication
(10) Pub. No.: US 2024/0428388 A1
(43) Pub. Date: Dec. 26, 2024

(54) Soybean Quality Assessment

(71) Applicant: Board of Supervisors of Louisiana State University and Agricultural and Mechanical College, Baton Rouge, LA (US)

(72) Inventors: Kevin Hoffseth, Baton Rouge, LA (US); Alexander Lee, St. Gabriel, LA (US)

(73) Assignee: Board of Supervisors of Louisiana State University and Agricultural and Mechanical College, Baton Rouge, LA (US)

(21) Appl. No.: 18/748,289

(22) Filed: Jun. 20, 2024

Related U.S. Application Data
(60) Provisional application No. 63/522,465, filed on Jun. 22, 2023.

(51) Int. Cl. G06T 7/00; G06T 7/11; G06T 7/40; G06T 7/50; G06T 7/90

(52) U.S. Cl. CPC G06T 7/0002; G06T 7/11; G06T 7/40; G06T 7/50; G06T 7/90; G06T 2207/10024; G06T 2207/30128; G06T 2207/30188

(57) ABSTRACT

A method and apparatus for evaluating soybean quality are disclosed. Automated or semi-automated image processing can be implemented with commercially available machine vision hardware. Post-harvest soybeans are separated, imaged, and analyzed to assess grain quality factors used in official grading. The system may be used prior to sale, purchase, further harvesting, or planting subsequent crops. The system reduces inspection errors, reduces variance in results, increases efficiency, enhances repeatability, and improves the standardization of soybean quality evaluation. Shape analysis, color analysis, and Haralick texture analysis are employed to determine when certain types of damage are present, to distinguish between types of damage, and to classify grains as smooth, cracked, or wrinkled. The system is sufficiently robust to allow successful deployment in rural, remote, and non-standard environments.

The benefit of the Jun. 22, 2023 filing date of U.S. provisional patent application Ser. No. 63/522,465 is claimed under 35 U.S.C. § 119 (e). The complete disclosure of the priority application is hereby incorporated by reference in its entirety.

### TECHNICAL FIELD

This invention pertains to a method and apparatus for assessing the quality of soybeans based on automated measurements of texture, shape, and color.

### BACKGROUND ART

The United States produced 4.44 billion bushels of soybeans worth an estimated $57.5 billion in 2021. The U.S. Department of Agriculture (USDA) defines a standard grading system to inspect and appraise soybeans. The resulting grade influences the price at which soybeans are sold. However, there exists a surprising amount of variance and possible errors in the inspection and grading process. The USDA grading system is based on quality factors such as heat, odor, moisture, and physical damage. It provides Visual Reference Images (VRIs) containing example images of each type of visual factor to aid in subjective grade determinations. Inspectors manually compare soybean samples to the VRIs to aid in determining the type and amount of damage. Testing and evaluation procedures may vary based on inspector experience and subjectivity, inspection site environment (lighting and measurement), and comparative local crop quality. Additionally, grade variation may arise in different farm or remote elevator sites, where companies or in-house inspectors may provide non-standard or non-certified grain analysis. There is an unfilled need for improved accuracy and automation in the grading process, particularly for improved evaluation of soybeans based on visual factors.

Image processing and analysis methods, which apply mathematical operations and algorithms to extract and interpret data from digital images, have been used in various fields, including medical imaging and diagnostics, circuit board quality control, and damage detection in crops such as soybeans. For example, there are automated methods for counting and separating damaged soybeans based on factors such as size, shape, color, mildew, insect damage, broken skins, and defective kernels. However, there has been little uniformity in the criteria used to assess soybeans. One approach has been to compare damaged soybeans with average values of normal soybeans, but there is no widely-accepted definition of what makes a soybean “normal.” Another method considers a soybean to be damaged if the number of white pixels in a binary image of a soybean is less than a set value. These prior methods have drawbacks; for example, the latter method can incorrectly determine that small and irregular but otherwise undamaged soybeans are “damaged.”

Another approach has been to use the RGB (red, green, blue) color space to classify soybean damage by sound, heat, green frost, and insect damage. In another approach, the HSI (hue, saturation, intensity) color space has been used with morphological operators to identify materials other than grains (MOGs), split soybeans, and contaminated soybeans. Mold damage has been identified based on variance in light reflectance of the soybean surface. Fungal disease in fruits, vegetables, and cereals has been assessed from images of leaves, stems, and fruit. Near-infrared hyperspectral imaging has been used to determine soybean crop viability.

Lin P. et al. Rapidly and exactly determining postharvest dry soybean seed quality based on machine vision technology. Sci Rep 9, 17143 (2019) reported the use of machine learning methods, such as jointly multi-modal bag-of-features, on post-harvest dry soybeans. Images in the visible spectrum for the test set were reported to reach an accuracy of 82.1% in classifying the soybeans as cracked or wrinkled.

de Medeiros, A. D. et al. Interactive machine learning for soybean seed and seedling quality classification. Sci Rep 10, 11267 (2020) reported results for examining soybean seed germination, using the open-source library ilastik (https://www.ilastik.org/) first to segment soybean seeds, and then to integrate with open-source machine learning classification algorithms, such as Linear Discriminant Analysis (LDA), Random Forest (RF), and Support Vector Machine (SVM).

Healthy, normal soybeans can, of course, express phenotypes with various shapes and sizes. A major drawback to existing approaches for soybean classification is the subjective nature of defining healthy or normal soybeans. Two issues particularly tend to arise from arbitrary definitions of “healthy.” The first is that the quality of the soybeans is compared to averages of what are presumed to be good soybeans. Second, these systems tend to be binary, meaning that a particular grain either matches a “good” soybean profile or is considered damaged. In practice, inspectors review many types of damage and assess them in a binary fashion with a subjective threshold. For example, U.S. Standards for Soybeans dictates that a soybean has mold damage if at least fifty percent of the seed coat is covered with mold, as determined by comparison to a preselected visual reference image.

There is an unfilled need for an integrated high-resolution automatic system to image, record, and analyze soybeans, particularly for a system that can be deployed remotely in field conditions to aid users in accurate, repeatable evaluation of soybean quality.

### Texture Analysis Using Haralick Features

Haralick, R. M., Shanmugam, K. & Dinstein, I. Textural Features for Image Classification. IEEE Transactions on Systems, Man, & Cybernetics, 3(6), 610-621 (1973) was a pioneering work in texture analysis of images. See also cvexplained.wordpress.com/2020/07/22/10-6-haralick-texture/.

Armi et al., Texture image analysis and texture classification methods-A review. International Online Journal of Image Processing and Pattern Recognition. Vol. 2, No. 1, pp. 1-29, (2019) defined texture in image processing as a function of spatial variation of the brightness intensity of the pixels. Multiple methods have been developed, such as grey-level co-occurrence matrixes (GLCM), Laplace filters, and granulometric analysis. Haralick features have been used in a wide variety of arenas: for example, to classify aerial and satellite images into land use categories, to analyze three-dimensional CT images, to characterize the microstructure of low-alloy steels, and to discriminate lung abnormalities in medical images.

Haralick features are based on the premise that texture and tone are related. “Tone” refers to the brightness of each pixel, ranging from black to white. A slight variation in the Haralick features of an image indicates that the prevailing property is tone, while a more substantial variation indicates that texture is the primary property. The tone is based on the varying levels of greyscale pixels in an image, and texture is related to the spatial or statistical distribution of the greyscale pixels. Haralick textural features are derived from a statistical analysis that characterizes the spatial relationship of pixels in a greyscale image. A GLCM is first constructed by determining how often two pixels with different grey levels appear next to one another in an image. Then, using the greyscale center of the image, the thirteen equations in Table 1 (or a subset of those equations) are applied to the GLCM to find Haralick features.

Texture principles are well-known in the art. These values are computed from the GLCM to characterize contrast, correlation, dissimilarity, entropy, homogeneity, and other properties. For example, “angular second moment” measures the textural uniformity of the image area. “Contrast” measures the local variations in the GLCM. “Correlation” measures how correlated a pixel is to its neighbor over the entire image. “Entropy” measures the randomness or disorder of the image area.

TABLE 1
Typical Haralick features and their respective definitions

| | |
|---|---|
| Angular Second | f₁ = Σᵢ₌₁Σⱼ₌₁{p(i, j)}² |
| Moment | |
| Contrast | f₂ = Σᵢ₌₁^{N}Σⱼ₌₁^{N}(i − j)²p(i, j) |
| Correlation | ${f}_{3} = \frac{{\sum }_{i = 1} {\sum }_{j = 1} ( ij ) p ( i , j ) - {μ}_{x} {μ}_{y}}{{σ}_{x} {σ}_{y}}$ |
| Difference Variance | f₁₀ = Σᵢ₌₀^{N}^{_{g}}⁻¹{(i − μ_{x-y})²p_{x-y}_{ⁱ} |
| Difference Entropy | f₁₁ = −Σᵢ₌₀^{N}^{_{g}}⁻¹p_{x-y}(i)log{p_{x-y}(i)} |
| Entropy | f₉ = −ΣᵢΣⱼp(i, j)log(p(i, j)) |
| IMOC 1 | ${f}_{12} = \frac{HXY - HXY 1}{max \{ HX , HY \}}$ |
| IMOC 2 | f₁₃ = (1 − exp[−2.0(HXY2 − HXY)])^{1/2} |
| Inverse Difference Moment | ${f}_{5} = {\sum }_{i} {\sum }_{j} \frac{1}{1 + {( i - j )}^{2}} p ( i , j )$ |
| Sum Average | f₆ = Σᵢ₌₂^{2N}^{_{g}}p_{x+y}(i) |
| Sum Entropy | f₈ = −Σᵢ₌₂^{2N}^{_{g}}p_{x+y}(i)log{p_{x+y}(i)} |
| Sum of Squares | f₄ = ΣᵢΣⱼ(i − μ)²p(i, j) |
| Variance | |
| Sum Variance | f₇ = Σᵢ₌₂^{2N}^{_{g}}(i − f₆)²p_{x+y}(i) |

Jitanan et al., Int J Elec & Comp Eng, Vol. 9, No. 5, October 2019 reported the use of contrast, entropy, correlation, and angular second moment to detect wrinkled seeds.

There is an unfilled need for improved techniques for the automated or semi-automated evaluation of soybean quality. Most prior approaches have been expressly or implicitly designed for use in an indoor laboratory setting. Few prior methods have been well-suited for deployment in rural, remote, and non-standard environments.

### USDA Grading Criteria

To evaluate post-harvest grain quality and determine grain grade, an individual soybean inspector typically samples, evaluates, and grades soybean grains. An official Federal Grain Inspection Service (FGIS) partner or authorized local agency then certifies the grain per the USDA Federal Grain Inspection Service, Grain Grading Primer, Subpart J—United States Standards for Soybeans, September 2023, www.federalregister.gov/documents/2023/07/14/2023-14856/united-states-standards-for-soybeans. As shown in Table 2, standard soybean classification uses five grades, from highest to lowest: Numbers 1 through 4, and U.S. Sample Grade. Special grade modifications are also possible. The soybean grade is determined by evaluating quality factors such as infestation, odor, garlicky, kind of grain, moisture, purple mottled or stained, stones, test weight, U.S. sample grade factors, heat damage, damaged kernels, soybeans of other colors, and splits.

TABLE 2
Grades and grade requirements for soybeans

| | Grades U. S. Nos. | | | |
|---|---|---|---|---|
| Grading factors | 1 | 2 | 3 | 4 |

Maximum percent limits of

| | | | | |
|---|---|---|---|---|
| Damaged kernels: | | | | |
| Heat (part of total) | 0.2 | 0.5 | 1.0 | 3.0 |
| Total | 2.0 | 3.0 | 5.0 | 8.0 |
| Foreign material | 1.0 | 2.0 | 3.0 | 5.0 |
| Splits | 10.0 | 20.0 | 30.0 | 40.0 |

Maximum count limits of

| | | | | |
|---|---|---|---|---|
| Other materials: | | | | |
| Animal filth | 9 | 9 | 9 | 9 |
| Castor beans | 1 | 1 | 1 | 1 |
| Crotalaria seeds | 2 | 2 | 2 | 2 |
| Glass | 0 | 0 | 0 | 0 |
| Stones¹ | 3 | 3 | 3 | 3 |
| Unknown foreign substance | 3 | 3 | 3 | 3 |
| Total² | 10 | 10 | 10 | 10 |

U.S. Sample Grade are soybeans that:
a. Do not meet the requirements for grades U.S. Nos. 1, 2, 3, or 4; or
b. Have a musty, sour, or commercially objectionable foreign odor (except smut or garlic odor); or
c. Are heating or otherwise of distinctly low quality.
¹In addition to the maximum count limit, stones must exceed 0.1 percent of the sample weight.
²Includes any combination of animal filth, castor beans, crotalaria seeds, glass, stones, and unknown foreign substances. The weight of stones is not applicable for total other material.

### DISCLOSURE OF THE INVENTION

We have discovered an improved method and apparatus for evaluating soybean quality. The novel approach uses automated or semi-automated image processing and can be implemented with commercially available machine vision hardware. Post-harvest soybean grains are separated, imaged, and analyzed to assess grain quality factors utilized in official grading. The system may be used prior to sale, purchase, further harvesting, or planting subsequent crops. In one embodiment, a special-purpose plate separates soybean grains from one another to enhance the imaging of individual grains, thereby improving the quality of the overall analysis. The process reduces inspection errors, reduces variance in results, increases efficiency, enhances repeatability, and improves the standardization of soybean quality evaluation. Shape analysis, color analysis, and Haralick texture analysis are employed to determine when certain types of damage are present, to distinguish between types of damage, and to classify grains as smooth, cracked, or wrinkled. The method and apparatus and their results are sufficiently robust to be deployed successfully in rural, remote, and non-standard environments.

### Soybean Positioning for Image Capture

One embodiment of the invention separates and processes soybeans to take multiple images of the outside surface of the seeds under controlled and consistent lighting at macro magnification or from 1:1 to 2:1 scale. An integrated computer then employs an algorithm to combine multiple images into an image with increased depth of field, allowing a high-resolution image of each soybean grain to be saved as data and evaluated subsequently by other algorithms to assess features such as shape, color, and texture.

In one embodiment, we designed and built a custom-made pillar plate to position multiple soybeans automatically. The plate is preferably made from metal, sanded smooth, and painted matte black to reduce light reflection and shadows, and to provide high contrast before adding the pillars to the plate. Matte black typically absorbs more light than other “shades” of “black,” and provides a stark contrast to the typical colors found in soybeans.

The imaging plate provides a suitable imaging background and generally separates the soybeans so that they do not touch one another, allowing for easier and faster segmenting of the images. In one embodiment, the camera is centered above and perpendicular to the surface of the plate. The size of the rectangular plate is chosen to match the image area of the camera that is employed.

The imaging plate in this embodiment has raised edges whose height is about three-fourths the diameter of a soybean grain, to help keep the soybean grains inside the imaging area. Within the edge boundaries, there are raised pillars whose height is roughly half the diameter of an average soybean grain, to help minimize shadows and facilitate segmentation. Although the size of the imaging plate can vary, the number of pillars is preferably chosen to fill (or nearly fill) the entire “interior” of the plate (inside the edges) equidistantly. The pillars form an obstacle to help prevent the soybean grains from clustering together.

The pillars (or cylinders) are approximately perpendicular to the surface of the plate. The junctions between the cylinders and the plate are filleted, i.e., a rounded junction or bump is added where each cylinder meets the plate, so that there are no sharp angles between the surface of the plate and the cylinders. The tops of the cylinders are also rounded. The rounding of the cylinders and the filleting of the junctions serve two functions. First, sharp angles and flat surfaces tend to reflect more light, so by rounding the top and filleting the base of the cylinders, the reflected light is better diffused to reduce anomalies in the digital image. Secondly, the soybeans are less likely to come to rest either on top of a bump or directly touching a bump; instead, the soybeans tend to roll into the lower elevations between the bumps, not only helping to separate the grains from one another but also helping to separate the grains from the pillars.

FIG. 1 illustrates one embodiment of a flat plate (with a grid 101 of pillars 102) to separate soybean grains from one another, and to facilitate the imaging of individual grains. In one embodiment, the dimensions of the SLA 3D printed prototype imaging plate are 140.00 mm wide×100.00 mm long×15.00 mm high. There is a 3.00 mm inset for the pillars. The sixty-six pillars have identical dimensions, each comprised of two concentric circles with a R2.44 mm interior circle radius and R4.37 mm exterior circle. The pillar height is 3.00 mm.

### Image Acquisition

In one embodiment, multiple soybean samples are imaged automatically, rapidly and repeatably, on a custom-fabricated, minimally reflective background, such as that depicted in FIG. 1. An overhead, computer-controlled Nikon Z6 captures soybean images under consistent lighting. Arrays of controllable LED lighting are positioned around the plate to allow sufficient and uniform lighting conditions. Images of individual grains are automatically isolated from the larger, multigrain images. This prototype embodiment allowed images of 15-20 soybeans to be captured simultaneously with the high-resolution digital camera, with a throughput of about 45 soybeans per minute. Future embodiments will caption images of 80-100 soybeans simultaneously, with correspondingly higher throughputs possible.

High-quality imaging of soybean grains, coupled with image processing and analysis, can illuminate differences between soybean cultivar phenotypes in response to growing conditions and plant stressors, especially regarding grain quality. In most circumstances, imaging should be performed promptly after harvest to avoid post-harvest changes in quality or possible decay. The novel system facilitates prompt analysis, since it can be embodied in hardware that is suited for deployment in rural, remote, and non-standard environments.

### Image Processing-Segmentation

Texture-based classification of soybean images can be used for visual grain quality analysis. One embodiment employed custom Python code to segment and process the images, calculate their shape, color, and Haralick texture values, and quantify visual damage.

Image processing methods are used to process and segment each sample. Mathematical morphology methods are used to determine average diameters and shapes. Spatial data and shape- and contour-based methods are used to calculate various trait values. RGB distributions of color, eccentricity (shape), and Haralick texture values are calculated. Visual damage is then quantified based on soybean grain morphology and relevant damage traits, as specified for example in the USDA Grain Inspection Handbook. Trait measurement values are stored in arrays and tables for subsequent statistical analyses, such as mean values, value distributions, correlation coefficients, and statistical significance.

FIG. 2 depicts an algorithmic flowchart showing the steps used in one embodiment to segment individual soybean images 201 and prepare them for texture analysis 202. The software algorithm imports the original image 203 and splits it into red, green, and blue channels 204. The red channel showed the greatest contrast when paired with the non-reflective black background. The red channel was therefore used in subsequent processing. To identify the contours 205, the edges of the grains were identified using the Canny edge method, and then the contours of each soybean were determined using the Suzuki method. A mask of the contours was placed over the original RGB image, and a square geometry that encompassed each individual contour was applied 206. Such algorithms are well known to those of skill in the art in computer vision.

A square geometry was used to segment individual soybeans 207 by first calculating each contour's centroid and major radius. The square is centered on the centroid of the contour, with each side being twice the length of the major radius. The square geometry was then given a multi-pixel cushion, and each was segmented from the original image. Repeating this step for each original image created nine new images 208, each containing a single soybean.

Next, the center of each soybean is segmented 202 for texture analysis. The color images are converted to greyscale 209 using a weighted method otherwise known in the art to convert each pixel's red, green, and blue values as follows: Grayscale=0.299 R+0.587 G+0.114 B. BT, I.-R. R. (2011). ITU Council Recommendation 601-7. Studio encoding parameters of digital television for standard 4:3 and wide screen 16:9 aspect ratios, www.itu.int/rec/R-REC-BT.601-7-201103-I/en (2011). A binary threshold is applied 210 for Canny edge detection 211.

Morphological operations 212 are applied to the binary image. There are five iterations of dilation and then five iterations of erosion using a two-pixel by two-pixel kernel. These iterations remove artifacts created by other particulates in the original image, such as shadows, dust, and dirt. The resulting contours in the image are detected, counted, and measured using the Suzuki method. The list of contours is then sorted based on the measured internal contour area, and the largest contour by area, which is presumably the soybean grain, is selected 213.

Using the calculated moment and centroid of the contour 214, an ellipse is fit to the contour using an algebraic distance algorithm 215. An inscribed rectangle is created using the computed major radius of the ellipse fit to the soybean contour 216 for each soybean. The soybean rectangles are segmented out 217 and converted to greyscale for texture analysis 218.

FIG. 3 visually illustrates the output of the steps of the algorithm. FIG. 3A: Greyscale Image 209, FIG. 3B: Binary Threshold 210, FIG. 3C: Edge of the soybean 211, FIG. 3D: Contoured image 213, FIG. 3E: Contoured image with the calculated center 214, FIG. 3F: Soybean fit with an ellipse 215, FIG. 3G: Soybean with interior rectangle 216, FIG. 3H: Segmented soybean rectangle for analysis 217.

### Image Processing—Shape, Color, Texture

Shape, color, and texture each play a significant role in assessing the quality of a soybean. The shape of a healthy soybean tends to be closer to an ellipse, while damaged soybeans are more likely to be cracked, wrinkled, or otherwise irregular. Custom Python code has been used to detect the edges of the grain automatically and to facilitate shape comparison. The RGB color values of damaged soybeans tend to differ from those of healthy soybeans, also giving a quantifiable difference. Healthy soybeans have a smooth surface texture, while damaged soybeans display cracked, wrinkled, or otherwise non-smooth texture.

One embodiment of this invention emphasizes the previously under-appreciated role of texture in evaluating soybean quality. For example, FIG. 4 illustrates three categories of soybean texture: smooth (FIG. 4A), cracked (FIG. 4B), and wrinkled FIG. 4C).

We evaluated thirteen Haralick texture features to classify soybean damage by smooth, cracked, and wrinkled categories. Initial output from the calculations consisted of four values for each feature, one for each of a reference pixel's nearest neighbor pixels at 0, 90, 180, and 270 degrees. These four values were then averaged to determine a single value for each Haralick feature.

All features provided a statistically significant difference between at least two texture groups. Initially, the Shapiro-Wilks and Levene tests failed for all Haralick features. However, the non-parametric Kruskal-Wallis test and a post-hoc Dunn's test using a Bonferroni-adjusted p-value were able to identify significant category differences. All tests used a significance level (alpha) of 0.05. The entropy FIG. 5A, inverse difference moment FIG. 5B, and sum average features FIG. 5C all provided significant differences between the three categories. The angular second moment feature FIG. 5D distinguished the wrinkled group from the other two groups. The remaining nine features we evaluated could only differentiate smooth from cracked or wrinkled. FIGS. 5A-5D show the distribution of our training data for each differentiating texture feature. The lower bound of each box plot indicates the first quartile of the data, the mid-line shows the median, and the upper bound represents the fourth quartile. These three values can be used, for example, in the classification algorithm depicted in FIG. 6. Table 3 summarizes our results for the statistical analyses of these Haralick features.

TABLE 3
Statistical Analysis Results for Haralick Features using nearest
neighbor pixels.

| | Significant | Significant | Significant |
|---|---|---|---|
| | Difference | Difference | Difference |
| | between | between | between |
| | Smooth and | Smooth and | Cracked and |
| | Cracked | Wrinkled | Wrinkled |
| Angular Second Moment | No | Yes | Yes |
| Contrast | Yes | Yes | No |
| Correlation | Yes | Yes | No |
| Difference Variance | Yes | Yes | No |
| Difference Entropy | Yes | Yes | No |
| Entropy | Yes | Yes | Yes |
| IMOC 1 | Yes | Yes | No |
| IMOC 2 | Yes | Yes | No |
| Inverse Difference | Yes | Yes | Yes |
| Moment | | | |
| Sum Average | Yes | Yes | Yes |
| Sum Entropy | Yes | Yes | No |
| Sum of Squares Variance | Yes | Yes | No |
| Sum Variance | Yes | Yes | No |

### Determining Soybean Quality

Factors affecting image capture include, e.g., camera operation, lighting, color, and fixture construction. A prototype embodiment for soybean-specific image analysis achieved robust image processing using machine vision algorithms and automated light sensing and control. We found that using Haralick texture features to identify and quantify damage in soybeans visually provided a more accurate quality assessment that better reflected the degree of actual damage than did manual comparisons based on a single visual reference image of a “perfect” soybean.

In one embodiment, a soybean image processing pipeline uses algorithmic measurement of quality factors to distinguish and analyze inspection-relevant soybean shape and color. Non-soybean sample components, i.e., foreign materials, are identified and excluded from the analysis. A gray-level co-occurrence matrix (GLCM) calculated from digital image pixel intensities determines Haralick texture features for soybean images, and distinguishes between smooth (non-damaged), wrinkled, and cracked soybeans. Image processing is automated and refined to simultaneously perform quality factor measurements using machine learning, artificial intelligence (AI), and artificial neural network techniques and methods otherwise known in the art. A dedicated library of soybean images is used to train the soybean-focused machine-learning algorithms. The custom software application optionally employs open-source libraries, such as ImageJ, OpenCV, Mahotas, and scikit-image.

The invention is well-suited for making portable embodiments that may be used in an agricultural or other remote setting to facilitate rapid soybean throughput and image processing rates. In one embodiment, a funnel feeds soybeans into a dispenser comprising four chambers that each hold 15-20 soybean grains. Each chamber is angled to dispense soybeans onto the imaging plate during rotation. The dispenser is press-fitted onto the end of a feed pipe to facilitate cleaning and the clearing of any blockages. A dispensing ramp spreads and separates the soybeans. The ramp is preferably about the same width as the imaging plate, helping the soybeans to spread out over the entire surface of the imaging plate. The ramp is angled to optimize the soybean travel rate onto the imaging plate. A camera and a processing circuit board have mounting hardware to adjust the camera's position to capture high-resolution images of the soybeans. A Raspberry Pi computer with Python-based microcontrollers, Arduino boards, and associated sensors, actuators, and optics enable high-throughput analysis of the soybean images. In this embodiment, the rate for the macro imaging setup was about 1 to 5 soybeans every 5 to 10 seconds, depending on the specific arrangement and dispersal technique used.

### Uses of Grain Quality Analysis

The results of the grain quality analysis may be used, for example, for grading soybean grains prior to sale or purchase; sorting the soybean grains by their assessed quality; or modifying or adapting the planting of a subsequent soybean crop.

### Grading Soybeans Prior to Sale or Purchase

The assessed shape, color, and texture may be used for grading soybeans prior to a sale or purchase, which is helpful for farming, production, purchasing, and evaluation for food, meal, or oil. In addition to its use with soybeans, the novel technique can also be used to analyze other grains, such as maize, wheat, rice, rye, oat, barley, millet, buckwheat, sorghum, and quinoa.

The United Soybean Board Strategic Plan Priority Areas of Innovation and Technology and Health and Nutrition's charter includes future soybean crop optimization. The novel system facilitates improved evaluation of visual soybean quality, thereby enabling producers to better evaluate post-harvest soybeans, understand and visualize the effects of planting decisions on harvested grain quality, and increase efficiency and consistency in the grading and sales process.

Sorting Grains by their Assessed Quality

Soybeans are sorted into categories based on their Haralick features. FIG. 5A, for example, depicts using the Haralick entropy feature to assess whether a grain is smooth, cracked, or wrinkled.

FIG. 6 depicts an algorithm that may be used to classify soybeans, for example, according to the inverse difference moment Haralick feature. Starting for example with a segmented rectangle 701, such as that shown in FIGS. 3G and 3H, we used nearest neighbor pixels to calculate various Haralick features 702, from which we selected the inverse difference moment value 703. In addition to the initial nearest neighbor results, we also sampled additional pixels 2, 3, 4, and 5 pixels away from the center 704. Using mean feature values from a training data set 705, we calculated the distance to mean 706. By comparing each value for the soybean of interest to the corresponding average value in the training data, we calculated a score. Four points are given to the smallest value, indicating that the sample soybean is closest to that texture group; two points are given to the median value, and one point is assigned to the largest value, which is indicative of being the least likely texture group for the sample. The highest point total across all three features identifies the sample category: smooth, wrinkled, or cracked.

Results in pilot studies showed that the calculated Haralick texture features from individual soybean images successfully distinguished among three basic texture categories found in soybeans: smooth, cracked, and wrinkled. In particular, the Haralick features entropy, inverse difference moment, and sum average showed significant differences among all three of these basic categories when calculated using the nearest neighbor pixel; while the other Haralick features only clearly distinguished one texture group from the other two (viz.: smooth, cracked, wrinkled), but did not clearly distinguish all three from each other.

When a five-pixel offset was used, some additional features also showed a significant difference in distinguishing the three soybean categories, namely: difference variance, difference entropy, information measure of correlation one, and information measure of correlation two. The feature inverse difference moment alone was able to correctly identify undamaged soybeans with an 88% accuracy rate, based on a distance to mean categorization.

### Adapting or Modifying the Planting of a Subsequent Soybean Crop

Damaged and discolored soybeans are less valuable, as graded per federal standards. We applied computational image processing methods to digital images to assess shape, color, and texture, providing links between visual quality indicators and overall soybean quality. Post-harvest, digital image analysis using the invention provides an improved, more economical evaluation of soybean quality that can guide growers and purchasers in the sale or purchase of a crop; and that can guide growers in adapting or modifying how future crops are planted and cultivated.

### BRIEF DESCRIPTION OF THE DRAWINGS

FIG. 1 illustrates one embodiment of a flat plate to separate soybean grains from one another, and to facilitate the imaging of individual grains.

FIG. 2 illustrates an algorithmic flowchart of steps to segment the images of individual soybeans and prepare them for texture analysis.

FIGS. 3A to 3H illustrate the results of the steps of the segmentation algorithm for a sample soybean image: Greyscale Image (FIG. 3A), Binary Threshold (FIG. 3B), Edge of the soybean (FIG. 3C), Contoured image (FIG. 3D), Contoured image with calculated center (FIG. 3E), Soybean fit with an ellipse (FIG. 3F), Soybean with interior rectangle (FIG. 3G), Segmented soybean rectangle for analysis (FIG. 3H).

FIGS. 4A to 4C illustrate three main categories of soybean classified by texture: smooth or undamaged (FIG. 4A), cracked (damaged) (FIG. 4B), and wrinkled (damaged) (FIG. 4C).

FIGS. 5A to 5D illustrate schematically the significant differences in the entropy (FIG. 5A), inverse difference moment (FIG. 5B), sum average (FIG. 5C), and angular second moment (FIG. 5D) features among smooth, cracked, and wrinkled soybean images.

FIG. 6 illustrates schematically an algorithmic flowchart of the steps to classify soybeans.

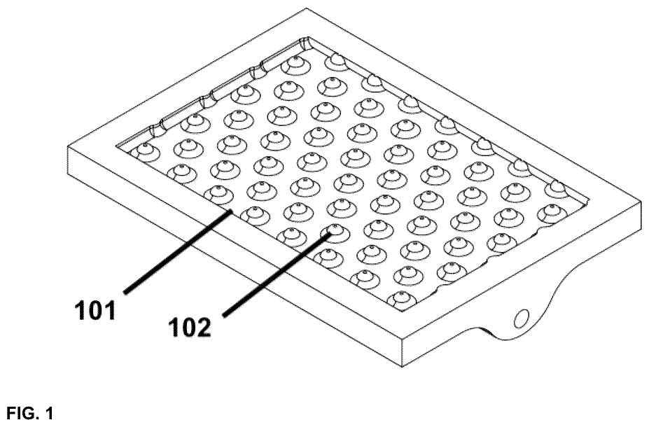

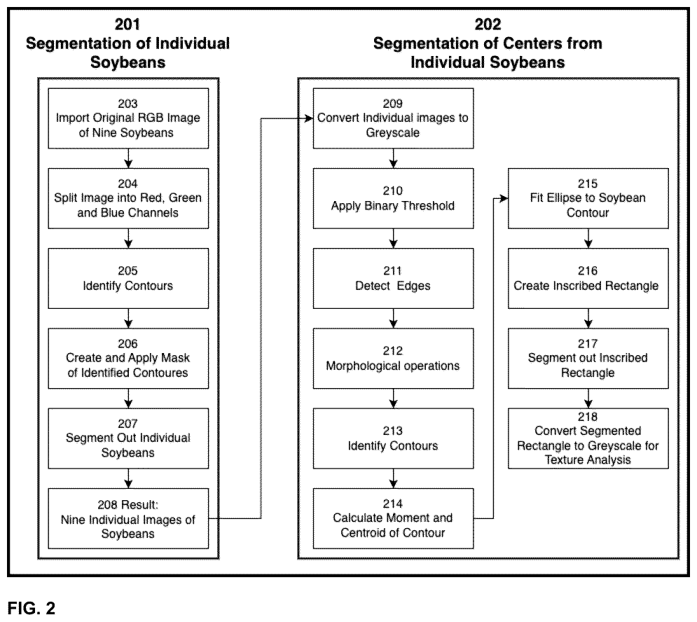

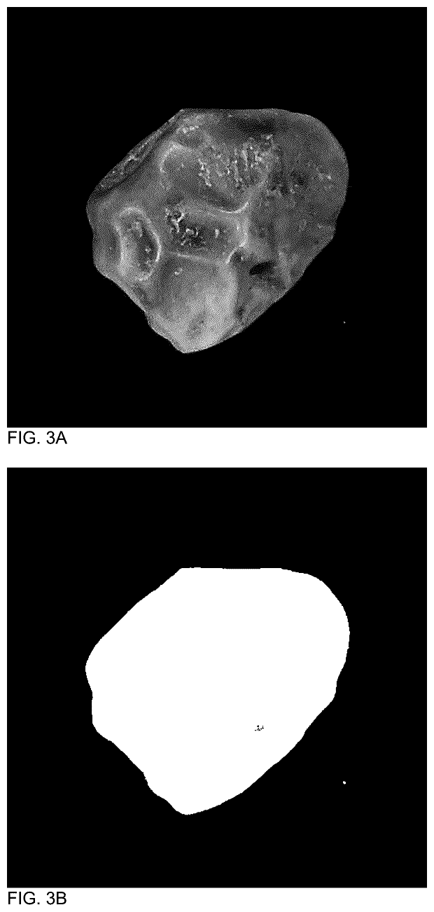

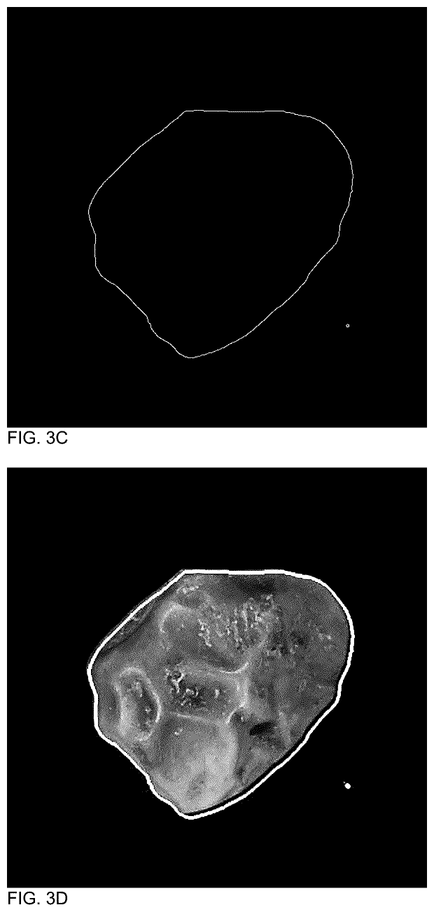

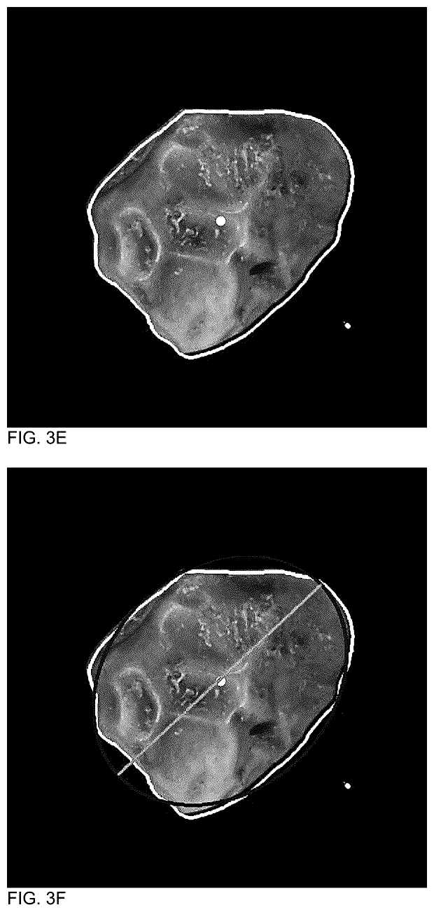

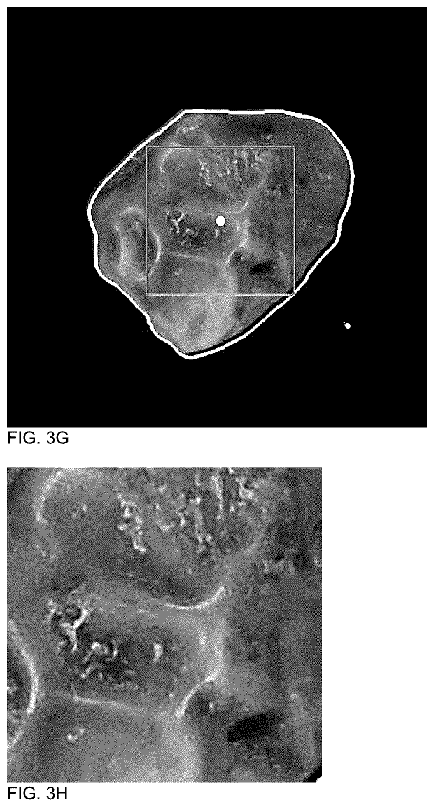

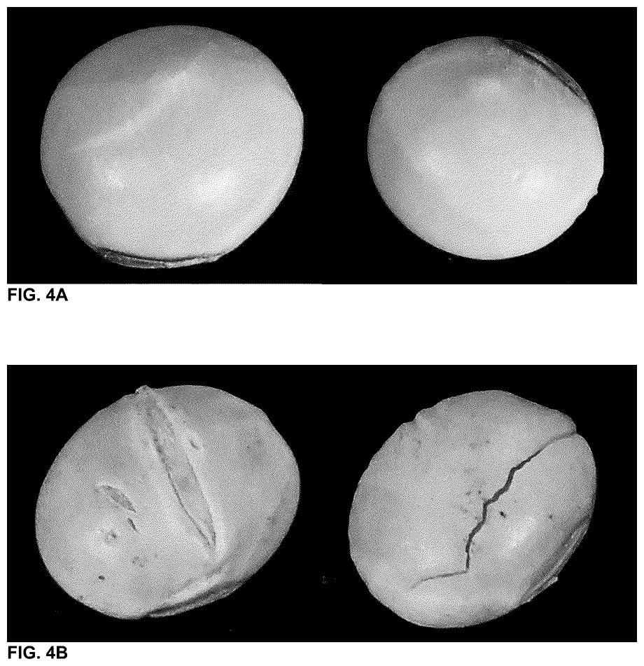

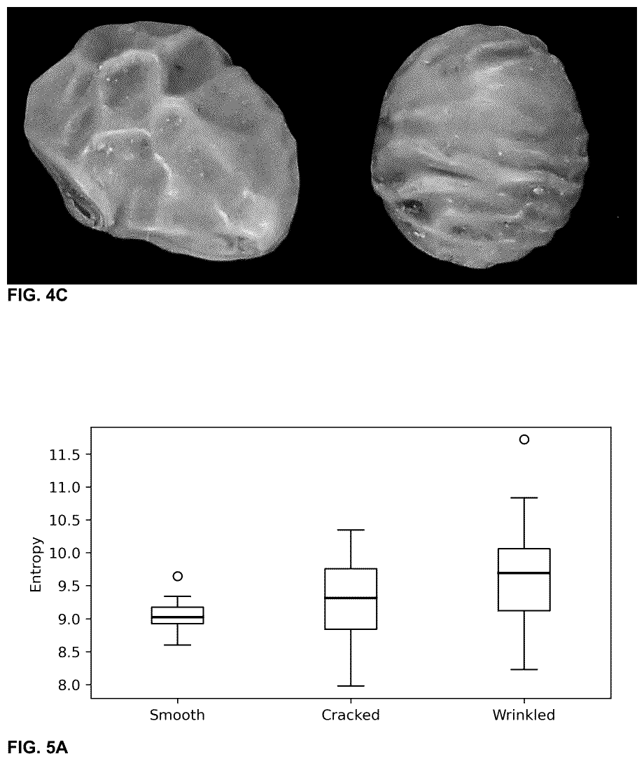

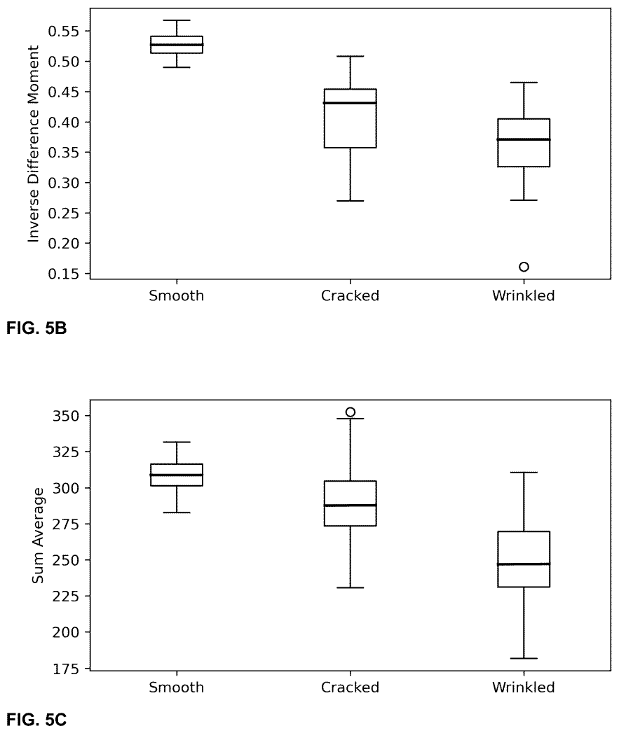

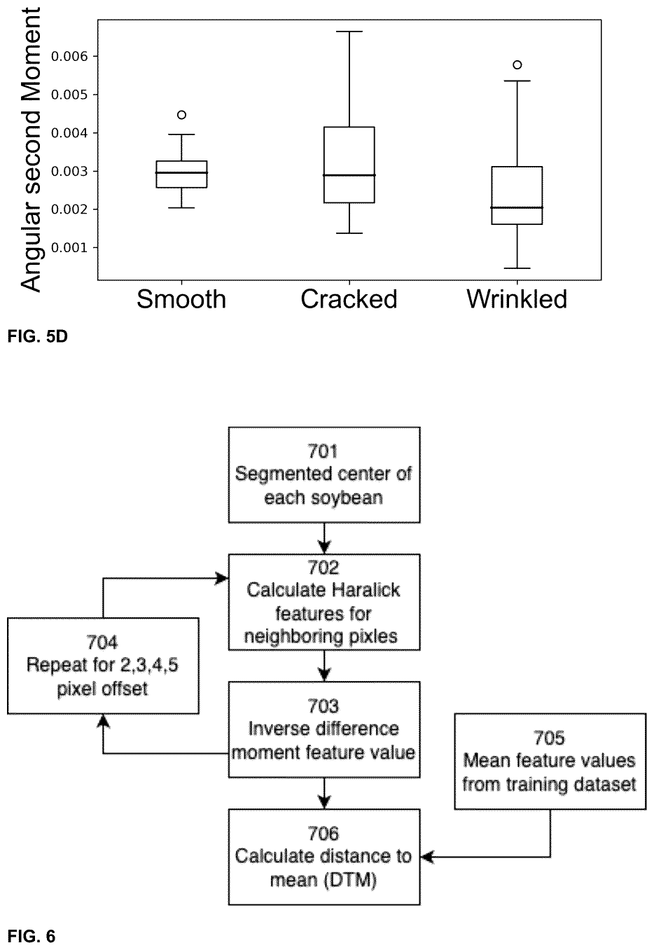

### MODES FOR CARRYING OUT THE INVENTION

One working embodiment used the image acquisition parameters set out in Table 4.

TABLE 4
Image acquisition parameters.

| | |
|---|---|
| Camera | 24.5-megapixel Nikon z6 |
| Lens | Nikon NIKKOR Z 24-70 mm lens at 70 mm |
| F-stop | F-5 |
| Shutter speed | 1/160 |
| ISO | 2500 |
| Lens height above | 27.5 cm |
| imaging platform | |
| Imaging platform | 12 cm by 8 cm matte black imaging plate |
| Lighting | Custom LED Light Array |
| Light temperature | 3700 K° |
| (measured) | |
| Brightness | 485 lux |
| (measured) | |

Other working embodiments used a conveyor belt or a table-top configuration, as summarized in Table 5.

TABLE 5
Soybean throughput

| Embodiment | | Rate (soybeans per |
|---|---|---|
| mode | Action | minute, spm) |
| Conveyor | Imaging | 1100 spm |
| Conveyor | Transfer | 30 min (to laptop) |
| Conveyor | Digital Analysis | 100 spm |
| Table-top | Imaging | 90 spm |
| Table-top | Imaging + Transfer | 30 spm |
| Table-top | Digital Analysis | 200 spm |
| Table-top | 100 soybean sample | 3 min 50 sec |

One embodiment employs a frame capable of supporting the weight of the soybeans to be imaged, a grain hopper, and a camera. The frame is made, for example, from 20 mm×20 mm T-slot framing. The resolution of the camera is preferably 6048×4024 pixels or greater. A standard 24 V AC-to-DC converter supplies power to the motors. A commercially-available, single-board computer with at least six 3.3-to-5 volt output pins and 8 GB of RAM controls the two motors. The soybeans should be well-distributed across the imaging plate, and the lighting should be measured and calibrated to establish a repeatable process. Best practices in preparing soybean samples before image capture includes preliminary removal of debris such as sticks, leaves, and soybean pods, to decrease blockages in the dispensing mechanism and feed tube.

The complete disclosure of all references cited in this specification are hereby incorporated by reference. In the event of an otherwise irreconcilable conflict, however, the present specification shall control.

What is claimed:

1. An automated or semi-automated process for determining the quality of a plurality of soybean grains, said process comprising the steps of:
(a) separating a plurality of soybean grains from one another on a generally flat plate comprising a plurality of pillars that facilitate the mechanical separation of the grains from one another;
(b) imaging the plurality of separated grains digitally;
(c) segmenting the one or more digital images to isolate images of individual grains;
(d) analyzing the segmented images to assess the color of the grain, the shape of the grain, and the texture of the grain;
(e) determining the quality of the soybean grains based on the assessed color, shape, and texture; and
(f) performing at least one of the following steps based on the determination of the soybean grain quality: grading the soybean grains prior to sale or purchase; or sorting the grains according to their determined quality; or adapting or modifying the planting of a subsequent soybean crop.

2. The process of claim 1, wherein said analyzing step comprises calculating Haralick texture values of the soybean grains from the segmented images.

3. The process of claim 2, wherein the calculated texture values are used to assess the numbers of individual soybean grains that are undamaged, or cracked, or wrinkled.

4. The process of claim 1, wherein said process is performed in a rural environment using portable hardware.

5. The process of claim 4, wherein said process is performed promptly after the soybeans grains have been harvested, to minimize post-harvest decay or other post-harvest changes in quality.

6. The process of claim 1, wherein the quality of at least 80 individual soybean grains is determined simultaneously.

7. The process of claim 1, wherein the quality of at least 15 individual soybean grains is determined simultaneously.
